(19) United States
(12) Patent Application Publication
(10) Pub. No.: US 2013/0017356 A1
(43) Pub. Date: Jan. 17, 2013

(54) SOFT COMPONENT WITH DECORATIVE SURFACE FINISH

(71) Applicant: Jason M. Hipshier, Hudsonville, MI (US)

(72) Inventor: Jason M. Hipshier, Hudsonville, MI (US)

(73) Assignee: Johnson Controls Technology Company, Holland, MI (US)

(21) Appl. No.: 13/635,649

(22) PCT Filed: Mar. 17, 2011
(86) PCT No.: PCT/US2011/028855

§ 371 Date: Sep. 17, 2012

Related U.S. Application Data
(60) Provisional application No. 61/315,211, filed on Mar. 18, 2010.

(51) Int. Cl. B32B 1/06; B05D 5/06

(52) U.S. Cl. 428/76; 427/261

(57) ABSTRACT

A soft component includes a cushion, and an outer skin disposed onto the cushion and configured to flex in response to deformation of the cushion. The soft component also includes a decorative layer disposed onto a show surface of the outer skin, and a top coat layer disposed onto the decorative layer and bonded to the show surface of the outer skin. The top coat layer is configured to flex with the outer skin while substantially maintaining continuity across the show surface of the outer skin.

### CROSS REFERENCE TO RELATED APPLICATION

This application claims priority from and the benefit of U.S. Provisional Application Ser. No. 61/315,211, entitled “SOFT COMPONENT WITH DECORATIVE SURFACE FINISH”, filed Mar. 18, 2010, which is hereby incorporated by reference in its entirety.

### BACKGROUND

The invention relates generally to a soft component with a decorative surface finish, such as in a vehicle.

Various soft components may be positioned throughout a vehicle interior. For example, a soft armrest may be coupled to a floor console located between a driver seat and a passenger seat. Furthermore, additional soft armrests may be coupled to door panels, positioned between rear seats and/or located within other areas of the vehicle interior. The vehicle interior may also include an instrument panel and/or dash board having soft portions, soft sun visors, head rests, or door panels having soft portions, among other soft vehicle interior components. Certain soft components may include a hard inner substrate, a soft cushion disposed about the hard inner substrate, and a flexible outer skin surrounding the soft cushion. The outer skin may be composed of a woven fabric, leather, or a synthetic material, for example.

Alternative soft components may be formed by a molding process in which two reactive compounds are mixed and poured into an open mold having the desired shape of the component. The mold is then closed and the mixture is allowed to expand and cure. In such processes, material chemistry as well as temperature variations within the mold may induce a high density flexible outer skin to form on the outer surface of the low density foam cushion. The resulting integral skin soft component may be suitable for use within the vehicle interior and/or various other applications (e.g., furniture, consumer products, etc.). Integral skin soft components may be less expensive to produce than soft components having a separate cushion and outer skin. However, the soft components having a separate skin may have a more desirable visual appearance because any suitable skin material (e.g., woven fabric, leather, etc.) may be applied to the cushion.

### BRIEF DESCRIPTION OF THE INVENTION

The present invention relates to a soft component including a cushion, and an outer skin disposed onto the cushion and configured to flex in response to deformation of the cushion. The soft component also includes a decorative layer disposed onto a show surface of the outer skin, and a top coat layer disposed onto the decorative layer and bonded to the show surface of the outer skin. The top coat layer is configured to flex with the outer skin while substantially maintaining continuity across the show surface of the outer skin.

The present invention also relates to a method of manufacturing a soft component including applying a decorative layer onto a show surface of an outer skin of the soft component. The outer skin is disposed about a cushion and configured to flex in response to deformation of the cushion. The method also includes applying a top coat layer onto the decorative layer such that the top coat layer is bonded to the show surface of the outer skin. The top coat layer is configured to flex with the outer skin while substantially maintaining continuity across the show surface of the outer skin.

The present invention further relates to a soft component prepared by a process including applying a decorative layer onto a show surface of an outer skin of the soft component. The outer skin is disposed about a cushion and configured to flex in response to deformation of the cushion. The process also includes applying a top coat layer onto the decorative layer such that the top coat layer is bonded to the show surface of the outer skin. The top coat layer is configured to flex with the outer skin while substantially maintaining continuity across the show surface of the outer skin.

### DRAWINGS

FIG. 1 is a perspective view of an exemplary vehicle that may include a soft component having a decorative surface finish.

FIG. 2 is a perspective view of an exemplary floor console that may be located within an interior of the vehicle of FIG. 1, including a soft armrest having a decorative surface finish.

FIG. 3 is a perspective view of the armrest, taken within line 3-3 of FIG. 2, illustrating the decorative surface finish.

FIG. 4 is a cross-sectional view of the armrest, taken along line 4-4 of FIG. 2, illustrating a flexible outer skin to which the decorative surface finish may be applied.

FIG. 5 is a detail of the cross-sectional view of the armrest of FIG. 4, taken within line 5-5, illustrating an exemplary decorative layer and top coat layer which may form the decorative surface finish.

FIG. 6 is a cross-sectional view of the armrest, as shown in FIG. 5, illustrating flexure of the outer skin and decorative surface finish.

FIG. 7 is a process flow diagram of an exemplary surface finishing process that may be utilized to apply the decorative layer and top coat layer to the armrest.

### DETAILED DESCRIPTION

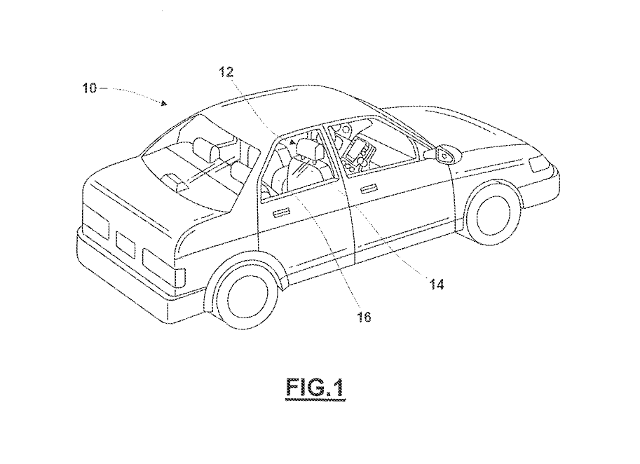

FIG. 1 is a perspective view of an exemplary vehicle 10 that may include a soft component having a decorative surface finish. As illustrated, the vehicle 10 includes an interior 12 having a seat 14, and a floor console 16. As discussed in detail below, the floor console 16 includes a soft armrest having a decorative surface finish configured to flex as the armrest deforms, thereby substantially maintaining the integrity of the surface finish. For example, in certain embodiments, the soft armrest includes an outer skin configured to flex in response to deformation of the soft armrest. The soft armrest also includes a decorative layer disposed onto a show surface of the outer skin, and a top coat layer disposed onto the decorative layer and bonded to the show surface of the outer skin. The top coat layer is configured to flex with the outer skin while substantially maintaining continuity across the show surface of the outer skin. This configuration enables a decorative surface finish to be applied to the soft armrest, thereby enhancing the visual appeal of the armrest.

Soft components, such as the armrest, may include a variety of structural configurations. For example, certain soft components may include a hard inner substrate, a soft cushion disposed about the hard inner substrate, and a flexible outer skin surrounding the soft cushion. The outer skin may be composed of a woven fabric, leather, or a synthetic material, for example. Alternative soft components may be formed by a molding process in which two reactive compounds are mixed and poured into an open mold having the desired shape of the component. The mold is then closed and the mixture is allowed to expand and cure. In such processes, material chemistry as well as temperature variations within the mold induce a high density flexible outer skin to form on the outer surface of the low density foam cushion. The resulting integral skin soft component may be suitable for use within the vehicle interior and/or various other applications (e.g., furniture, consumer products, etc.).

Soft components having a separate skin may have a more desirable visual appearance because any suitable skin material (e.g., woven fabric, leather, etc.) may be applied to the cushion. However, separate skin soft components may be more expensive to produce than integral skin soft components due to the labor associated with assembling the components and the cost of the skin material. Consequently, it may be desirable to apply a decorative surface finish to integral skin soft components to enhance the visual appearance. For example, an integral skin soft component may simulate the appearance of a fabric skin by employing a surface finish that looks like a fabric pattern in conjunction with a textured outer skin. Such a configuration may increase the visual appeal of soft components within a vehicle, while reducing manufacturing costs compared to employing separate skin soft components. Furthermore, it should be appreciated that the flexible surface finish described below may be applied to separate skin soft components which employ a synthetic (e.g., vinyl, etc.) outer skin to enhance the appearance of the component and/or simulate a more expensive (e.g., leather, etc.) outer skin.

While the decorative surface finish is described below with reference to an armrest, it should be appreciated that the decorative surface finish may be applied to other soft components within the vehicle 10. For example, the decorative surface finish may be applied to other armrests, such as armrests attached to doors or positioned between rear seats, soft portions of the instrument panel and/or dash board, sun visors, head rests, or soft portions of door panels, among other soft vehicle interior components. Furthermore, it should be appreciated that the decorative surface finish may be applied to soft components within other vehicles, such as planes, boats, trains, etc. Moreover, the decorative surface finish described below may be applied to furniture, consumer products, or any other suitable soft component having an outer skin capable of supporting the decorative surface finish.

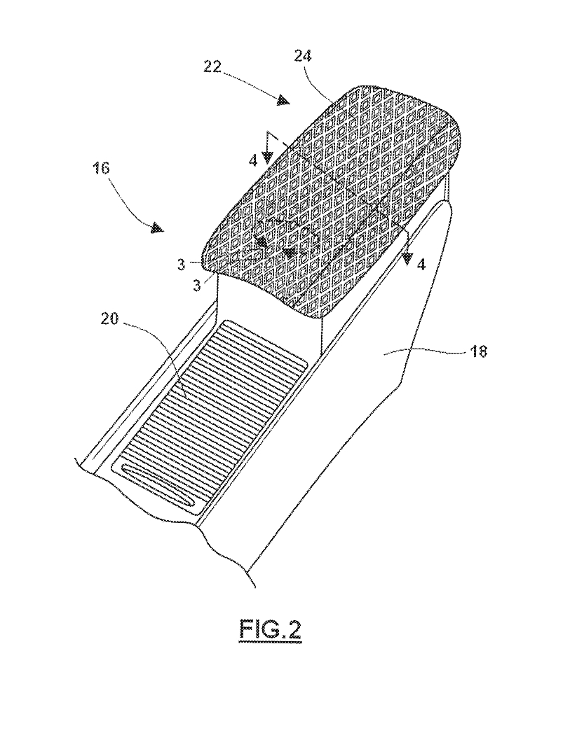

FIG. 2 is a perspective view of an exemplary floor console 16 that may be located within an interior 12 of the vehicle 10 of FIG. 1, including a soft armrest having a decorative surface finish. As illustrated, the floor console 16 includes a body 18 enclosing one or more storage compartments. For example, the floor console 16 may include a storage compartment underneath the illustrated tambour door 20 and/or the armrest 22. As will be appreciated, the tambour door 20 may be configured to transition between the illustrated closed position to an open position that facilitates access to a storage compartment positioned at a front portion of the console 16. Similarly, the armrest 22 may rotate to expose another storage compartment positioned at a rear portion of the console 16. In certain configurations, the two storage compartments may be connected such that an occupant may access either storage compartment via the tambour door 20 or the armrest 22. It should be appreciated that alternative embodiments may include additional storage compartments positioned throughout the floor console 16.

As discussed in detail below, the armrest 22 includes an outer skin 24 having a decorative surface finish configured to flex as the armrest 22 deforms, thereby substantially maintaining the integrity of the surface finish. In the present configuration, a decorative layer, such as an ink layer, is disposed onto a show surface of the outer skin 24. As illustrated, the decorative layer includes a series of diamond-shaped decorations adorning the show surface of the outer skin 24. As will be appreciated, substantially any pattern, picture or image may be applied to the show surface of the outer skin 24 via the decorative layer. In addition, the decorative layer may include substantially any color or combination of colors. As discussed in detail below, the outer skin 24 may have a base color, selected based on the desired appearance of the armrest 22 and/or the selected colors of the decorative layer.

In the present configuration, a top coat layer is disposed onto the decorative layer and bonded to the show surface of the outer skin 24. The top coat layer is configured to flex with the outer skin 24 while substantially maintaining continuity across the show surface of the outer skin 24. Such a configuration may substantially reduce or eliminate the possibility of cracks forming within the top coat as the outer skin 24 flexes. For example, as the armrest 22 deforms under the weight of an occupant arm, the top coat may flex with the outer skin 24. Due to the structural properties of the top coat, the surface finish may remain bonded to the outer skin 24, and may maintain its visual appearance even as the armrest 22 deforms during use.

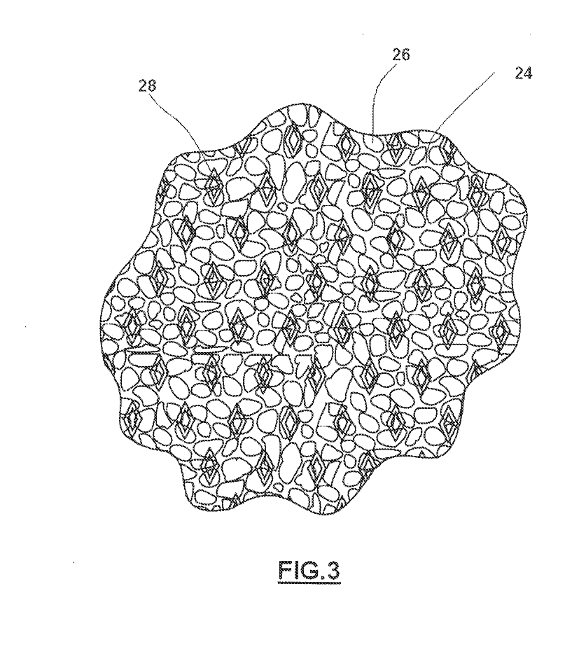

FIG. 3 is a perspective view of the armrest 22, taken within line 3-3 of FIG. 2, illustrating the decorative surface finish. As illustrated, the outer skin 24 is textured with multiple protrusions or bumps 26. As discussed in detail below, such a textured surface may be formed by mixing two reactive components and pouring the mixture into a mold having a textured outer surface which corresponds to the illustrated pattern. As the outer skin 24 forms adjacent to the outer surface of the mold, the textured pattern is imparted onto the outer skin 24. As will be appreciated, substantially any suitable textured pattern may be disposed onto the show surface of the outer skin 24. For example, certain embodiments may include a textured pattern that simulates the appearance of fabric or leather skin. However, it should be appreciated that alternative embodiments may employ a substantially smooth show surface. In the present embodiment, a graphical pattern 28 is disposed onto the show surface of the outer skin 24. As previously discussed, substantially any pattern, picture or image may be applied to the show surface of the outer skin 24 via the decorative layer. In the present configuration, a top coat layer is disposed onto the decorative layer and bonded to the show surface of the outer skin 24. The top coat layer serves to protect the decorative layer from wear, and may include a variety of finishes, such as matte, or glossy, for example. In addition, the top coat layer is configured to flex with the outer skin 24 while substantially maintaining continuity across the show surface of the outer skin 24.

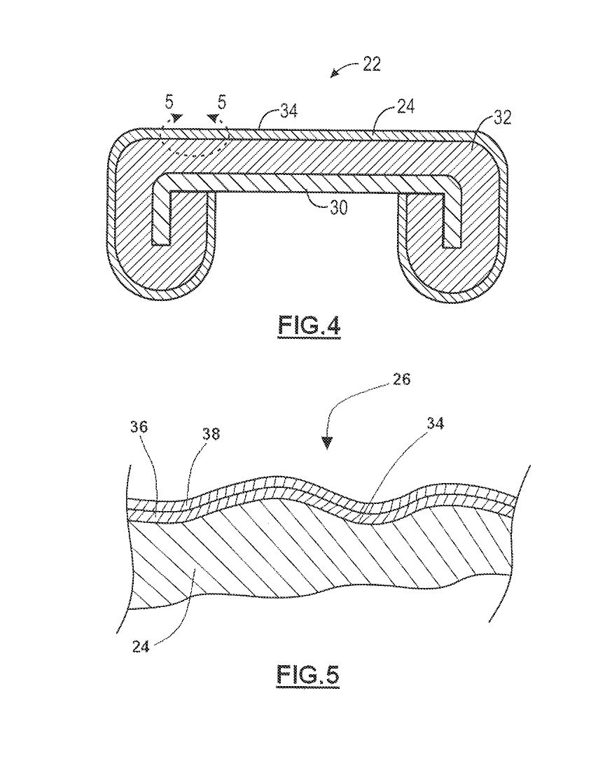

FIG. 4 is a cross-sectional view of the armrest 22, taken along line 4-4 of FIG. 2, illustrating a flexible outer skin to which the decorative surface finish may be applied. In the present configuration, the armrest 22 includes a hard substrate 30, a soft cushion 32, and the flexible outer skin 24. The substrate 30 may be composed of a substantially rigid material such as metal or hard plastic, for example. The cushion 32 is disposed adjacent to the hard substrate 30 and is configured to deform under a load. In this configuration, the weight of an occupant arm may be distributed across a larger area of the armrest 22, thereby increasing occupant comfort. The outer skin 24 is disposed onto the cushion 32, thereby protecting the cushion 32 and providing a desired appearance.

As will be appreciated, softness of the cushion 32 may be measured by determining the resistance of the cushion to deformation. A variety of tests may be employed to determine the resistance to deformation of the cushion. For example, one known indentation force deflection (IFD) test measures the force sufficient to indent a 50 square inch cushion section by a fraction (e.g., 25%) of its thickness. Based on the 25% IFD test, soft materials may have a range of approximately between 6 to 24 pounds, intermediate materials may have a range of approximately between 24 to 36 pounds, and hard materials may have a range of approximately between 36 to 45 pounds. In certain embodiments, the cushion 32 may be composed of a material having a 25% IFD of approximately between 24 to 36 pounds. Such a softness range may provide a desired level of passenger comfort. However, it should be appreciated that alternative embodiments may employ cushions having a higher or lower softness to achieve the desired properties of the soft component.

In addition, the outer skin 24 may be composed of a material particularly selected to provide durability, while maintaining flexibility. As will be appreciated, flexibility and durability of the outer skin 24 may be measured by determining the hardness of the constituent material. One measure of hardness is the resistance to indentation, otherwise referred to as Durometer, denoted in the Shore A scale, for example. Within the Durometer scale, materials are generally characterized based on ranges. Hard or rigid elastomers generally include those having a Durometer greater than about 90 Shore A, soft elastomers generally include those having a Durometer of about 60 Shore A to about 90 Shore A, and super-soft elastomers generally include those having a Durometer below about 60 Shore A. In certain embodiments, the outer skin 24 may be composed of a material having a Durometer of approximately between 20 to 60 Shore A. Utilizing such a material may facilitate bending of the outer skin 24, while maintaining durability and smoothness of the show surface. However, it should be appreciated that alternative embodiments may include an outer skin 24 composed of a material having a Durometer of less than 20 Shore A or more than 60 Shore A.

In certain configurations, the cushion 32 and the outer skin 24 may be separate components. For example, the outer skin 24 may be coupled to the cushion 32 by an adhesive, for example. In alternative embodiments, the outer skin 24 and hard substrate 30 may be placed into a mold. A foam layer or other flexible material may then be injected between the outer skin 24 and the hard substrate 30, thereby forming the cushion 32. In further embodiments, the outer skin 24 may be integral with the cushion 32. For example, the armrest 22 may be formed by an injection molding process in which a resin is injected into a mold having a desired shape. Certain injection molding processes mix a foaming/blowing agent with the resin to form the soft foam cushion 32. In such processes, temperature variations within the mold induce the flexible outer skin 24 to form on the outer surface of the foam cushion 32.

Once the armrest 22 has been formed, the exposed or show surface 34 of the outer skin 24 may receive a decorative surface finish configured to flex as the armrest deforms. As discussed in detail below, a decorative layer is disposed onto the show surface 34 of the outer skin 24, and a top coat layer is disposed onto the decorative layer. The top coat layer is configured to flex with the outer skin 24 while substantially maintaining continuity across the show surface 34 of the outer skin 24. This configuration enables a decorative surface finish to be applied to the soft armrest 22, thereby enhancing its visual appeal and/or simulating a more expensive outer skin (e.g., leather, etc.).

FIG. 5 is a detailed cross-sectional view of the armrest 22 of FIG. 4, taken within line 5-5, illustrating an exemplary decorative layer and top coat layer which may form the decorative surface finish. In the present embodiment, a decorative layer, such as the illustrated ink layer 36, is disposed onto the show surface 34 of the outer skin 24. As previously discussed, the ink layer 36 may include a decorative image, picture or pattern, such as the pattern 28 illustrated in FIG. 3. In addition, the ink layer 36 may include substantially any color or combination of colors. Furthermore, it should be appreciated that the ink layer 36 may be composed of multiple layers forming the desired image, picture or pattern. For example, certain printing processes may apply each primary color (e.g., yellow, magenta and cyan) via separate stages of the printing process. In alternative embodiments, the decorative layer may include an appliqué, a stain applied to the outer skin 24, or other decorative surface finishes.

In certain embodiments, the ink layer 36 may be applied by a hydrographic printing process. In such embodiments, a desired pattern is printed on a sheet of water-soluble film. The sheet is then placed on the surface of water within a hydrographic printing tank. Next, a solvent is sprayed onto the sheet, thereby dissolving the film and leaving the pattern floating on the surface of the water. As the armrest 22 is dipped into the tank, surface pressure of the water transfers the ink layer 36 onto the show surface 34 of the outer skin 24. Once the ink layer 36 dries, the pattern becomes permanently affixed to the show surface 34.

In further embodiments, the ink layer 36 may be applied by other printing processes, such as flexography, dye-sublimation printing, screen printing, and digital printing, among others. For example, if the ink layer 36 is applied by a screen printing process, a screen is placed in contact with the show surface 34 of the outer skin 24. The screen includes a stencil configured to block ink flow to desired regions of the show surface 34. Consequently, when ink is applied to the screen (e.g., via a roller or squeegee), an ink layer 36 is formed having a pattern corresponding to portions of the screen not covered by the stencil. Furthermore, if the ink layer 36 is applied by a digital printing process (e.g., inkjet printing, etc.), a printing device applies an ink layer 36 onto the show surface 34 having a pattern corresponding to a digital image of the desired pattern.

In certain embodiments, the color of the outer skin 24 is particularly selected to interact with the ink layer 36 to establish a desired appearance. For example, in embodiments in which the armrest 22 is formed by a molding process, a colorant may be mixed into the foam before the foam is injected into the mold. Alternatively, a paint may be applied to the mold before the foam in injected. The paint bonds with the foam adjacent to the outer surface of the mold, thereby establishing a desired color of the outer skin 24. For example, the color of the outer skin 24 may be selected to match the color of a fabric seat covering. In addition, the ink layer 36 and/or texture of the show surface 34 may be configured to simulate a fabric layer. In such a configuration, the armrest 22 may substantially match the appearance of the seats 14.

After the ink layer 36 is applied, a top coat layer 38 is disposed onto the ink layer 36 and bonded to the show surface 34 of the outer skin 24. The top coat layer 38 serves to protect the ink layer 36 from wear, and may also provide an enhanced appearance to the armrest 22. For example, the top coat layer 38 may have a glossy finish configured to match other finishes within the vehicle interior 12. Alternatively, the top coat layer 38 may have a dull or matte finish configured to simulate the appearance of a fabric covering. In the present embodiment, the outer skin 24 is textured with the protrusions or bumps 26. In such an embodiment, the top coat layer 38 may fill in the region between protrusions 26, thereby providing the armrest 22 with a smoother appearance.

As previously discussed, the top coat layer 38 is configured to flex with the outer skin 24 while substantially maintaining continuity across the show surface 34 of the outer skin 24. Such a configuration may substantially reduce or eliminate the possibility of cracks forming within the top coat layer 38 as the outer skin 24 flexes. For example, as the armrest 22 deforms under the weight of an occupant arm, the top coat 38 may flex with the outer skin 24. Due to the structural properties of the top coat layer 38, the surface finish may remain bonded to the outer skin 24, and may maintain its visual appearance even as the armrest 22 deforms during use. In certain embodiments, the top coat layer 38 may include a urethane blend specifically configured to provide sufficient flexibility to maintain continuity across the show surface 34 as the outer skin 24 flexes. For example, the top coat layer 38 may be a blend of urethane and acrylic. However, it should be appreciated that alternative embodiments may employ a top coat layer 38 composed exclusively of an acrylic compound or a urethane compound. Further embodiments may employ other compounds to achieve the desired flexibility of the top coat layer 38.

FIG. 6 is a cross-sectional view of the armrest 22, as shown in FIG. 5, illustrating flexure of the outer skin and decorative surface finish. As illustrated, an occupant finger 40 is depressing the armrest 22 in the direction 42, thereby inducing the outer skin 24 to flex. Because the ink layer 36 and the top coat layer 38 are disposed onto the outer skin 24, the layers 36 and 38 flex with the skin 24. As illustrated, where the finger 40 contacts the armrest 22, the top coat layer 38 has translated a distance 44 in the direction 42 from the position illustrated in FIG. 5. As a result, a curvature is induced within the top coat layer 38. Because the top coat layer 38 is composed of a flexible material, the possibility of crack formation within the decorative surface finish is substantially reduced or eliminated. As a result, the appearance of the decorative surface finish may be maintained despite flexing of the outer skin 24, the ink layer 36 and/or the top coat layer 38.

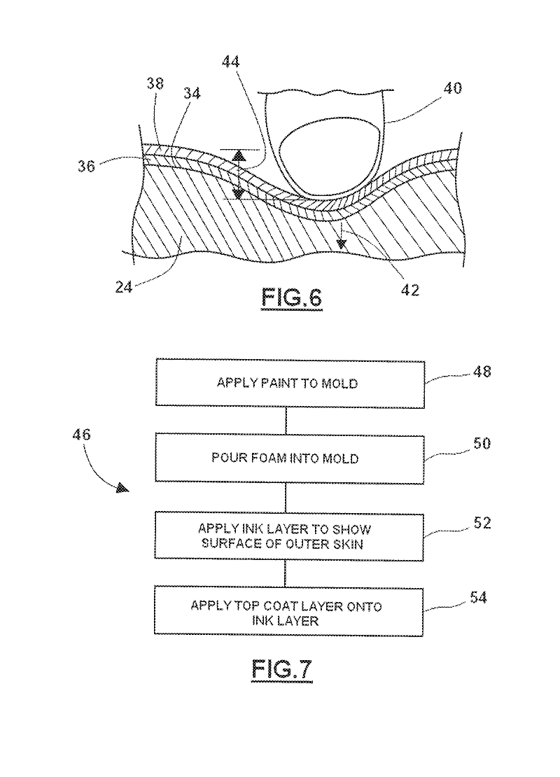

FIG. 7 is a process flow diagram of an exemplary surface finishing process 46 that may be utilized to apply the decorative layer, such as the ink layer 36, and top coat layer 38 to the armrest 22. While a molding process is described below, it should be appreciated that application of the ink layer 36 and the top coat layer 38 may be substantially similar for armrests 22 produced by other manufacturing processes, such as the separate skin armrest described above. First, as represented by block 48, paint is applied to a mold to establish a base color of the outer skin 24. As previously discussed, the paint may be disposed adjacent to an outer surface of the mold such that the paint bonds with the portion of the poured foam which forms the outer skin 24. As a result, the outer skin 24 may achieve a desired base color for the ink layer 36. Next, as represented by block 50, two reactive compounds are mixed and poured into the mold, thereby forming the cushion 32 and the outer skin 24. In addition, due to the material chemistry as well as temperature variations within the mold, the high density flexible outer skin 24 will be formed which surrounds the low density foam cushion 32. In certain embodiments, the hard substrate 30 may be placed in the mold prior to the injection of foam such that the cushion 32 bonds to the hard substrate 30 during the molding process. Once the molding process is complete, the armrest 22 may be removed from the mold.

Next, as represented by block 52, the ink layer 36 is applied to the show surface 34 of the outer skin 24. As previously discussed, the ink layer 36 may be applied by a hydrographic printing process in which the show surface 34 of the outer skin 24 is dipped into a hydrographic printing tanking including an ink pattern floating on a water surface. As the armrest 22 is dipped into the tank, surface pressure of the water transfers the ink layer 36 onto the show surface 34 of the outer skin 24. Once the ink layer 36 dries, the pattern becomes permanently affixed to the show surface 34. As will be appreciated, alternative embodiments may employ other techniques for applying the ink layer 36 to the outer skin 24. In further embodiments, alternative decorative layers (e.g., appliqués, stains, etc.) may be applied to the outer skin 24. Finally, as represented by block 54, the top coat layer 38 is applied onto the ink layer 36 and bonded to the show surface 34 of the outer skin 24. As previously discussed, the top coat layer 38 is configured to flex with the outer skin 24 while substantially maintaining continuity across the show surface 34 of the outer skin 24. Such a configuration may substantially reduce or eliminate the possibility of cracks forming within the top coat layer 38 as the outer skin 24 flexes. For example, as the armrest 22 deforms under the weight of an occupant arm, the top coat 38 may flex with the outer skin 24. Due to the structural properties of the top coat layer 38, the surface finish may remain bonded to the outer skin 24, and may maintain its visual appearance even as the armrest 22 deforms during use.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A soft component, comprising:
a cushion;
an outer skin disposed onto the cushion and configured to flex in response to deformation of the cushion;
a decorative layer disposed onto a show surface of the outer skin; and
a top coat layer disposed onto the decorative layer and bonded to the show surface of the outer skin, wherein the top coat layer is configured to flex with the outer skin while substantially maintaining continuity across the show surface of the outer skin.

2. The soft component of claim 1, wherein the show surface of the outer skin is textured.

3. The soft component of claim 1, wherein the outer skin is integral with the cushion.

4. The soft component of claim 1, wherein the decorative layer comprises an ink layer.

5. The soft component of claim 4, wherein the ink layer is applied by a hydrographic printing process.

6. The soft component of claim 1, wherein the outer skin is composed of a material having a hardness of greater than approximately 20 Shore A Durometer and less than approximately 60 Shore A Durometer.

7. The soft component of claim 1, wherein the cushion is composed of a material having a softness of greater than approximately 24 pounds and less than approximately 36 pounds on a 25% indentation force deflection scale.

8. The soft component of claim 1, wherein the top coat layer comprises acrylic, urethane, or a combination thereof.

9. The soft component of claim 1, wherein the outer skin is painted to establish a desired base color.

10. A method of manufacturing a soft component, comprising:
applying a decorative layer onto a show surface of an outer skin of the soft component, wherein the outer skin is disposed about a cushion and configured to flex in response to deformation of the cushion; and
applying a top coat layer onto the decorative layer such that the top coat layer is bonded to the show surface of the outer skin, wherein the top coat layer is configured to flex with the outer skin while substantially maintaining continuity across the show surface of the outer skin.

11. The method of claim 10, wherein applying the decorative layer onto the show surface of the outer skin comprises dipping the outer skin into a hydrographic printing tank.

12. The method of claim 10, comprising forming the outer skin by mixing two reactive compounds and pouring the mixture into an open mold.

13. The method of claim 12, comprising applying paint to the mold prior to pouring the mixture to establish a desired base color of the outer skin.

14. The method of claim 12, wherein the mold comprises a textured surface configured to establish a corresponding texture on the show surface of the outer skin.

15. A soft component prepared by a process comprising:
applying a decorative layer onto a show surface of an outer skin of the soft component, wherein the outer skin is disposed about a cushion and configured to flex in response to deformation of the cushion; and
applying a top coat layer onto the decorative layer such that the top coat layer is bonded to the show surface of the outer skin, wherein the top coat layer is configured to flex with the outer skin while substantially maintaining continuity across the show surface of the outer skin.

16. The soft component of claim 15, wherein the outer skin is composed of a material having a hardness of greater than approximately 20 Shore A Durometer and less than approximately 60 Shore A Durometer.

17. The soft component of claim 15, wherein the cushion is composed of a material having a softness of greater than approximately 24 pounds and less than approximately 36 pounds on a 25% indentation force deflection scale.

18. The soft component of claim 15, wherein the decorative layer comprises an ink layer, and the ink layer is applied by a hydrographic printing process, a digital printing process, a screen printing process, or a combination thereof.

19. The soft component of claim 15, wherein the show surface of the outer skin is textured.

20. The soft component of claim 15, wherein the outer skin is integral with the cushion.
